(19) United States
(12) Patent Application Publication
(10) Pub. No.: US 2022/0275198 A1
(43) Pub. Date: Sep. 1, 2022

(54) HIGH PLA CONTENT PLASTIC MATERIAL COMPRISING PPGDGE

(71) Applicant: CARBIOLICE, RIOM (FR)

(72) Inventors: Clementine ARNAULT, Clermont Ferrand (FR); Bertrand DE BACKER, Mons (BE); Julien CAYUELA, Saint-Saulve (FR); Philippe DUBOIS, Ciplet (BE)

(21) Appl. No.: 17/625,885

(22) PCT Filed: Jul. 10, 2020
(86) PCT No.: PCT/EP2020/069540

§ 371 Date: Jan. 10, 2022

(30) Foreign Application Priority Data
Jul. 10, 2019 (FR) FR1907729

(51) Int. Cl. C08L 67/02

(52) U.S. Cl. CPC C08L 67/02; C08L 2205/03; C08L 2205/08

(57) ABSTRACT

The present invention relates to a plastic composition based on biodegradable and biosourced polyesters, in particular for preparing plastic films.

### FIELD OF THE INVENTION

The present invention relates to a plastic material composition based on biodegradable and biosourced polyesters, in particular for preparing films in plastic material.

### STATE OF THE ART

Biosourced and biodegradable films are known, containing starches or starch derivatives and polyesters, in particular monolayer or multilayer films employed in particular to manufacture bags in plastic material. These bags are especially used for wrapping food products and in particular fruit and vegetables.

Particular mention is made of the films described in patents and patent applications U.S. Pat. Nos. 6,841,597, 5,436,078, WO 2007/118828, WO 2002/059202, WO 2002/059199, WO 2002/059198, U.S. Pat. No. 9,096,758, WO 2004/052646 and CN 106881929. The biosourced and/or biodegradable materials employed, for the maintaining of mechanical properties adapted to use thereof, remain costly.

An increase in PLA content (polylactic acid) allows an increase in the content of less costly biosourced materials, for example in compositions of biodegradable resins (WO 2018/056539, U.S. Pat. No. 7,807,773) or of block copolymers (EP 2 844 685). This increase in PLA content generally requires the use of a compatibilizer to allow mixing of PLA with another polyester such as PBAT (polybutylene adipate terephthalate). Said compatibilizers are known for this application, in particular polyacrylates, such as the products marketed under the trade names Joncryl® ADR (Dong & al., International Journal of Molecular Sciences, 2013, 14, 20189-20203; Ojijo & al., Polymer 2015, 80, 1-17; EP 1 699 872; EP 2 258 775; EP 2 679 633; WO 2013/164743; WO 2015/057694).

However, an increase in PLA content is made to the detriment of the mechanical properties of the products prepared with these polymer compositions. Therefore, the films obtained with said compositions having high PLA content, despite the addition of a compatibilizer, have reduced mechanical properties compared with films containing less PLA, in particular in terms of elongation at break and tear strength. Increasing the PLA content in prior art compositions does not allow the specifications of bag manufacturing to be met.

The invention sets out to solve this technical problem by selecting a particular compatibilizer to be added to the mixture of polyesters.

### DESCRIPTION OF THE INVENTION

The invention concerns a plastic material composition which comprises:

a. at least 20% by weight of PLA (polylactic acid),

b. at least 45% by weight of a polyester selected from among PBAT (polybutylene adipate terephthalate), PHAs (polyhydroxyalkanoates), PBS (polybutylene succinate), PBSA (polybutylene succinate adipate) and mixtures thereof, and

c. Poly (Propylene Glycol) DiGlycidyl ether (PPGDGE) as PLA/Polyester compatibilizer.

The invention also concerns a flexible film of plastic material having a composition comprising a composition of the invention obtained in particular by extruding a composition of the invention.

Finally, the invention concerns a method for preparing a composition of the invention which comprises at least the successive steps of mixing and melting with:

1. The PLA and compatibilizer, followed by:

2. The polyester selected from among PBAT (polybutylene adipate terephthalate), PHAs (polyhydroxyalkanoates), PBS (polybutylene succinate), PBSA (polybutylene succinate adipate) and mixtures thereof.

### DETAILED DESCRIPTION OF THE INVENTION

The invention concerns a plastic material composition which comprises:

a. at least 20% by weight of PLA (polylactic acid),

b. at least 45% by weight of polyester selected from among PBAT (polybutylene adipate terephthalate), PHAs (polyhydroxyalkanoates), PBS (polybutylene succinate), PBSA (polybutylene succinate adipate) and mixtures thereof,

c. Poly (Propylene Glycol) DiGlycidyl Ether (PPGDGE), a PLA/Polyester compatibilizer, and optionally

d. a plasticizer selected in particular from among lactic acid oligomers (LAOs) and citrate esters.

Unless otherwise stated, percentages are weight percentages relative to the total weight of the composition to which they refer.

The constituents of the composition of the invention are well known to persons skilled in the art and are notably described in the aforementioned publications, patents and patent applications, particularly the polyesters and PLA routinely employed in the biodegradable and/or biosourced plastic materials industry, for the preparation in particular of biosourced and biodegradable films.

PLA is formed from levorotatory lactic acid monomers (L) and/or dextrorotatory monomers (D), the content of (L) and (D) monomers possibly varying. The PLA can be a mixture of levorotatory PLA (PLLA) mostly formed of (L) monomers, and dextrorotatory PLA (PDLA) mostly formed of (D) monomers.

Advantageously, polyester b) is PBAT. When used in a mixture with other polyesters such as PHAs, PBS or PBSA, PBAT is in majority proportion in the mixture of polyesters other than PLA, preferably more than 60% of the mixture, more preferably more than 70%, further preferably more than 80% by weight. In one particular and preferred embodiment of the invention, polyester b) other than PLA is essentially PBAT, more preferably it is composed of PBAT alone.

Poly (Propylene Glycol) DiGlycidyl Ethers (PPGDGEs) are also called glycidyl ethers, and particularly described as «reactive plasticizers» in patent application WO 2013/104743, used to prepare block copolymers with PLA and PBAT. They are also identified as a liquid epoxy resin by DOW marketed under the reference «D.E.R.™ 732P», or as an aliphatic epoxy resin by HEXION, marketed under the reference «Epikote™ Resin 877».

The composition of the invention may optionally comprise other PLA/Polyester compatibilizers associated with PPGDGE. Said PLA/Polyester compatibilizers are well known to skilled persons and are particularly selected from among polyacrylates, terpolymers of ethylene, acrylic ester and glycidyl methacrylate (e.g. marketed under the trade name Lotader® by Arkema), PLA-PBAT-PLA triblock copolymers, maleic anhydride-grafted PLAs (PLA-g-MA) or maleic anhydride-grafted PBATs (PBAT-g-MA), particularly poly(ethylene-co-methyl acrylate-co-glycidyl methacrylate) described in particular by Dong & al. (International Journal of Molecular Sciences, 2013, 14, 20189-20203) and Ojijo & al. (Polymer 2015, 80, 1-17), and more particularly marketed under the trade name JONCRYL® by BASF, preferably grade ADR 4468.

Preferably, the composition of the invention comprises at least 25% PLA, more preferably at least 28% PLA, further preferably at least 30% PLA. The PPGDGE compatibilizer allows PLA contents to be obtained of up to at least 35%, even at least 40%, up to about 50% PLA.

The content of polyester b) is advantageously at least 50% of the total weight of the composition. In one advantageous embodiment of the invention, the content of polyester b) is between 60 and 70%.

The content of PPGDGE as compatibilizer c) in the composition of the invention is advantageously at least 0.1%, preferably 0.5 to 2%, more preferably 0.5 to 1.5%, advantageously about 1% by weight relative to the total weight of the composition.

If other compatibilizers are associated with PPGDGE, the content of compatibilizers other than PPGDGE will be between 0.2 and 2%.

The composition of the invention may also comprise plasticizers. These plasticizers are well known to skilled persons, for example lactic acid oligomers (LAOs) or citrate esters.

LAOs are also plasticizers well known to skilled persons as biosourced materials. These are lactic acid oligomers having a molecular weight of less than 1500 g/mol. They are preferably esters of lactic acid oligomers, the carboxylic acid terminal thereof being blocked by esterification with an alcohol, in particular a C1-C10 linear or branched alcohol, advantageously a C6-C10 alcohol or a mixture thereof. Special mention is made of the LAOs described in patent application EP 2 256 149 with their mode of preparation, and the LAOs marketed by Condensia Quimica, in particular under reference Glyplast® OLA 2 having a molecular weight of 500 to 600 g/mol, and Glyplast® OLA 8 having a molecular weight of 1000 to 1100 g/mol. In one preferred embodiment of the invention, the LAOs have a molecular weight of at least 900 g/mol, preferably from 1000 to 1400 g/mol, more preferably from 1000 to 1100 g/mol. The molecular weight of LAOs can be measured by size exclusion chromatography (SEC) or matrix-assisted laser desorption/ionization coupled to time-of-flight mass spectrometry (MALDI-TOF) following usual methods for measuring the molecular weight of these oligomers.

Citrate esters are also plasticizers known to skilled persons, in particular as biosourced materials. Particular mention is made of triethyl citrate (TEC), triethyl acetyl citrate (TEAC), tributyl citrate (TBC), tributyl acetyl citrate (TBAC), preferably TBAC.

The content of plasticizer, in particular LAOs or citrate esters, in the composition of the invention is advantageously at least 0.5%, preferably 1 to 5%, more preferably 2 to 4%, advantageously about 2.5%.

The composition of the invention may comprise other usual additives included in the composition of plastic materials, in particular to prepare films, such as mineral or organic fillers, natural fibres, pigments or dyes, etc. In one particular example, the composition of the invention may comprise calcium carbonate, in particular up to 5% calcium carbonate.

In one particular case, the composition of the invention, relative to the total weight of the composition, comprises:

a. at least 25% by weight of PLA (polylactic acid), preferably at least 28%, more preferably at least 30% PLA,

b. at least 60% by weight of a polyester selected from among PBAT (polybutylene adipate terephthalate), PHAs (polyhydroxyalkanoates), PBS (polybutylene succinate), PBSA (polybutylene succinate adipate) and mixtures thereof, in particular PBAT,

c. 0.5 to 1.5% by weight of PPGDGE, and

d. 0 to 2% by weight of another compatibilizer, more preferably from the polyacrylate family,

e. 0 to 4% by weight of plasticizer.

In particular, the composition of the invention comprises:

a. 30 to 40% by weight of PLA (polylactic acid),

b. 60 to 67% by weight of a polyester selected from among PBAT (polybutylene adipate terephthalate), PHAs (polyhydroxyalkanoates), PBS (polybutylene succinate), PBSA (polybutylene succinate adipate) and mixtures thereof, in particular PBAT,

c. 0.5 to 1.5% by weight of PPGDGE,

d. 0 to 4% by weight of plasticizer, in particular 2 to 4%, and

e. 0 to 2% by weight of another compatibilizer, more preferably from the polyacrylate family,

f. 0 to 5% by weight of calcium carbonate.

One particular composition of the invention comprises:

a. 25 to 35% by weight of PLA (polylactic acid),

b. 69% by weight of a polyester selected from among PBAT (polybutylene adipate terephthalate), PHAs (polyhydroxyalkanoates), PBS (polybutylene succinate), PBSA (polybutylene succinate adipate) and mixtures thereof, in particular PBAT,

c. 1% by weight of PPGDGE.

The composition of the invention may also comprise enzymes capable of degrading polyesters to improve the biodegradability of the film of the invention. In one particular embodiment, the composition of the invention may comprise enzymes capable of degrading PLA. Said enzymes and the mode of incorporation thereof in thermoplastic films are known to skilled persons and are notably described in patent applications WO 2013/093355, WO 2016/198652, WO 2016/198650, WO 2016/146540 and WO 2016/062695. Preferably, these enzymes are selected from among proteases and serine proteases. In one particular embodiment, the serine proteases are selected from among Proteinase K of Tritirachium album, or PLA-degrading enzymes derived from Amycolatopsis sp., Actinomadura keratinilytica, Laceyella sacchari LP175, Thermus sp., or Bacillus licheniformis, or reformulated commercial enzymes known to degrade PLA such as Savinase®, Esperase®, Everlase® or any enzyme from the subtilisin family CAS 9014-01-1 or any functional variant.

When the composition of the invention also comprises polyester-degrading enzymes, degrading PLA in particular, the composition with added enzymes is advantageously the following:

80 to 98% by weight, preferably 90 to 98% by weight of the composition high in PLA previously defined, and

2 to 20%, preferably 2 to 10% of an enzymatic composition comprising 0.0005 to 10% enzyme associated with 50 to 95% of a low-melting point polymer and optionally associated with a stabilizer. This stabilizer can be selected from among polysaccharides, preferably from natural gums such as gum arabica.

Said enzymatic composition can be prepared by extruding 50 to 95%, preferably 70 to 90% of a low-melting point polymer, and 5 to 50%, preferably 10 to 30% of a liquid enzymatic formulation comprising 0.01 to 35% enzymes, 19 to 60% water and 15 to 70% stabilizer.

Such enzymatic compositions and/or liquid enzymatic formulations suitable for preparing polymer mixtures high in PLA are notably described in application WO 2019/043134.

One preferred enzymatic composition particularly comprises 50 to 95% of low-melting point polymer, in particular polycaprolactone (PCL), preferably 70 to 90%, from 0.001 to 10% enzymes, preferably 1 to 6%, and 1.5 to 21% gum arabica, preferably 3 to 7%.

The composition with added enzymes of the invention advantageously comprises:

at least 20% PLA, advantageously at least 25% PLA,

at least 40% PBAT,

at least 0.08% PLA/PBAT compatibilizer, advantageously at least 0.5%,

at least 0.4% plasticizer,

at least 0.002% enzyme, advantageously at least 0.05% and

at least 1.4% low-melting point polymer, advantageously at least 1.5%.

It is within the reach of persons skilled in the art to adapt the enzyme content, and hence the content of low-melting point polymer and other additives contributed by the enzymatic composition, as a function of objectives for rate of PLA degradation by the enzymes.

The invention also concerns a method for preparing compositions of the invention, with the previously described compounds and proportions thereof, comprising the steps of:

1. mixing the PLA and compatibilizer at a temperature at which the PLA is partially or fully molten, then

2. adding the polyester selected from among PBAT (polybutylene adipate terephthalate), PHAs (polyhydroxyalkanoates), PBS (polybutylene succinate), PBSA (polybutylene succinate adipate) and mixtures thereof at a temperature at which the previously obtained mixture is molten.

The plasticizer can be added at any instant of the method: at step 1 at the same time as the PLA and compatibilizer, between step 1 and step 2, at step 2 or after step 2.

In one particular case, the invention concerns a method for preparing a composition of the invention comprising the steps of:

1. mixing at least 25% by weight (relative to the total weight of the composition of the invention) of PLA and between 0.5 and 1.5 weight % of compatibilizer at a temperature equal to or higher than 120° C., then

2. adding at least 60% of polyester selected from among PBAT (polybutylene adipate terephthalate), PHAs (polyhydroxyalkanoates), PBS (polybutylene succinate), PBSA (polybutylene succinate adipate) and mixtures thereof, at a temperature at which the previously obtained mixture is molten,

the addition of plasticizer selected from among LAOs or citrate esters possibly being made at any instant of the method.

The preparation of the composition is conducted following usual methods of the art, in particular by extrusion. The extruded molten mixture is cooled to form granules and is generally transformed into an end product of particular form (films, flexible or rigid parts).

When the products prepared with the composition of the invention also comprise polyester-degrading enzymes such as defined above, these are added either when preparing the composition or at the time of preparing the end products by mixing granules having the composition of the invention with the enzymes in a form suitable for incorporation thereof and following usual methods known to skilled persons.

To facilitate incorporation of the enzymes in the composition of the invention, advantageously the enzymes are used in the form of an adapted composition allowing both preservation and transport of the enzymes, but also promoting their incorporation by preventing degradation thereof at this incorporation step. Said compositions are known to skilled persons and are described in particular in application WO 2019/043134.

In particular, addition of enzymes to the composition of the invention can advantageously be conducted as follows: mixing between 80% and 98% of a composition of the invention with between 2% and 20% of a composition comprising an enzyme degrading polyesters and PLA in particular, the percentages being given by weight relative to the weight of the final composition.

The invention also concerns any product in plastic material composed of or comprising constituent elements of the composition of the invention.

In a first embodiment, the composition is in the form of granules prepared following usual techniques. These granules can be stored, transported as granules entering into the manufacture of products in plastic material irrespective of the form or utilization thereof, which can be called «end products». These may be films, or flexible or rigid parts of shape and volume adapted to their intended use.

The methods for preparing these end products are well known to skilled persons, and particularly comprise usual techniques in the plastics processing industry such as blown film extrusion, extrusion blow moulding, cast film extrusion, calendering and thermoforming, injection moulding, compression moulding, rotational moulding, coating, stratification, expansion, pultrusion, compression-granulation. Said operations are well known to skilled persons who will easily be able to adapt the conditions of the method according to type of intended product in plastic material (e.g. temperature, residence time, etc.).

The composition of the invention is particularly adapted for the production of plastic films. The films of the invention can be produced following usual methods of the art in particular by blown film extrusion. The films can be prepared directly on leaving the extrusion die used to prepare the composition of the invention, or they can be prepared from granules having the composition of the invention which are melted using usual techniques, in particular by extrusion.

The invention therefore also concerns a film having the composition such as previously defined with or without enzymes. The films of the invention can be monolayer or multilayer films. For multilayer films, at least one of the layers has the composition such as previously defined.

In particular, the multilayer film can be a film comprising at least 3 layers of type ABA, ABCA or ACBCA, layers A, B and C having a different composition. In general, layers A and B comprise PLA and/or a polyester, advantageously a composition of the invention.

Layers C, if any, are provided to contribute particular properties to the products of the invention, more particularly to contribute gas-barrier properties against oxygen in particular. Said barrier materials are well known to skilled persons and in particular PVOH (polyvinyl alcohol), PVCD (polyvinyl chloride), PGA (polyglycolic acid), cellulose and derivatives thereof, milk proteins or polysaccharides and mixtures thereof in any proportions.

The composition of the invention is particularly adapted for association with polyester-degrading enzymes to manufacture biodegradable plastic films.

For multilayer films such as defined above, and in particular films of ABA, ABCA or ACBCA type, the enzymes can be contained in all the layers or else in only one of the layers, for example in layers A and B or only in layer A or layer B.

In one particular embodiment of the invention, the two layers A are composed of a composition of the invention comprising PLA, the polyester and PPGDGE such as defined above, without enzymes. The enzymes are contained in layer B, either in a composition of the invention with enzymes such as defined above, or in a particular composition and in particular an enzyme composition in a low-melting point polymer defined above.

Plastic films, in particular monolayer films and multilayer films having compositions such as previously defined, have both a high PLA content and maintain mechanical properties such as those sought-after for preparing biodegradable and biosourced bags, in particular films for mulching, packaging, wrapping of food and non-food products, particularly for wrapping food products.

For this purpose, the constituents of the composition of the invention are preferably selected from among products compatible for use with foods.

The films of the invention advantageously have a thickness of less than 100 μm, more advantageously less than 50 μm, 40 μm or 30 μm, preferably less than 20 μm, more preferably from 6 to 20 μm, in particular 10 μm.

The plastic films obtained with the composition of the invention advantageously have the following properties:
elongation at break greater than 120% in longitudinal direction and greater than 180% in transverse direction, measured according to standard EN ISO 527-3; and/or
tear strength greater than 20 N/mm in transverse direction of the film, measured according to standard EN ISO 6383-1, in particular greater than 30 N/mm, this together with a high PLA content.

The elongation at break of the plastic film obtained with the composition of the invention is advantageously at least 120% in longitudinal direction, preferably at least 180%.

The tear strength of the plastic film obtained with the composition of the invention is advantageously at least 18 N/mm in transverse direction of the film, preferably at least 20 N/mm, in particular at least 35 N/mm.

In one particular embodiment, the plastic films obtained with the composition of the invention also have the following properties:

1. elastic modulus greater than 700 MPa in longitudinal direction and greater than 210 MPa in transverse direction, measured according to standard EN ISO 527-3 and/or

2. maximum stress higher than 20 MPa in longitudinal direction and higher than 13 MPa in transverse direction, measured according to standard EN ISO 527-3

The composition of the invention can also be used to produce rigid plastic products such as food packaging.

### EXAMPLES

### Example 1

Materials Used:

The Poly-L-lactide (PLA) used is PLA grade 4032D sold by NatureWorks. It has a number average molecular weight of about 111 000 g/mol (PS equivalent) and dispersity of 2.06.

The poly (butylene adipate-co-terephthalate) (PBAT) used is grade Solpol 1000 N sold by GioSoltech, having a number average molecular weight of about 46 000 g/mol (PS equivalent) and dispersity of 3.17. The chemical microstructure thereof determined by ¹H NMR analysis shows molar percentages of butylene adipate sequences and butylene terephthalate sequences of 51.2% and 48.8% respectively.

The poly(propylene glycol)diglycidyl ether used is sold by Sigma Aldrich. It has a number average molecular weight of 640 g/mol (supplier's data).

Preparation of the Compounds:

Tests were conducted on a Leistritz co-rotating twin-screw extruder having a barrel diameter D of 18 mm and L/D ratio of 50. The extruder comprises 10 independent heating zones. The rotation speed of the screws is 120 rpm. The set temperatures of the barrels (1 to 10) are given in Table 1. The temperature of the die is 190° C.

TABLE 1

| Zone | 1 | 2 | 3 | 4 | 5 | 6 | 7 | 8 | 9 | 10 |
|---|---|---|---|---|---|---|---|---|---|---|
| Temperature | 3 | 195 | 195 | 195 | 195 | 195 | 90 | 90 | 90 | 90 |

The PLA and PBAT were dried in a ventilated oven at 60° C. before extrusion.

The PLA and PBAT were dispensed into barrel 1 at respective flow rates of 0.36 kg/h and 0.83 kg/h, via independent granule feeders. The PPGDGE was dispensed into barrel 4 at a flow rate of 12.0 g/h, via a piston pump.

The extruded rod was cooled in a water bath and granulated.

Two compounds were produced. The first having the composition 30% PLA 4032D+70% PBAT Solpol 1000N and used as reference compound. This compound is designated C ref. The second having the composition 99.0% (30% PLA 4032D+70% PBAT Solpol 1000N)+1.0% PPGDGE. This compound is designated C.

These compounds, at a second stage, were fed into a single-screw extruder equipped with a film blowing device. The film produced from compound C ref is designated F ref. The film produced from compound C is designated F.

Measurements and Tests Conducted:

Scanning Electron Microscopy (SEM) on the Compounds Produced

Preparation of the Samples

A rod of the compound was cryofractured and coated with a layer of carbon on the fractured portion to obtain a conductive sample.

Measurements:

Observations were made on MEB-FEG Hitachi SU8020 apparatus. The acceleration voltage was 5 kV. The secondary electron detector was used.

DSC (Differential Scanning Calorimetry) on the Films Produced by Blown Film Extrusion

The melt temperature (Tm) and crystallization temperature (Tc), enthalpies of fusion (ΔHf) and crystallization (ΔHc), glass transition temperatures (Tg) and variations in heat capacity (ΔCp) of the polymers were measured using a differential scanning calorimeter: TA Instrument (DSC Q200). The operating conditions were the following: isotherm at −80° C. for 5 min, 1^{st} heating from −80° C. to 195° C. (10° C./min), isotherm for 2 min, cooling from 195° C. to −80° C. (10° C./min), isotherm for 5 min, 2^{nd} heating from −80° C. to 195° C. (10° C./min).

The melt and crystallization temperatures were determined taking the temperatures at endothermal and exothermal peaks. Glass transition temperatures were determined considering the inflection point.

The crystallinities of PBAT and PLA were determined considering enthalpy of 114 J/g for 100% crystalline PBAT and enthalpy of 93 J/g for 100% crystalline PLA.

Tear Tests on Films Produced by Blown Film Extrusion

The tear strength of the films was characterized in longitudinal direction (MD) and transverse direction (TD), on a Lloyd LS5 testing machine equipped with 20 N load cell and following standard EN ISO 6383-1. The experimental conditions are summarized in Table 2.

TABLE 2

| | Sample | Distance | Crosshead |
|---|---|---|---|
| | size | between jaws | speed |
| Test | (mm*mm) | (mm) | (mm/min) |
| Tear test | 50*150 | 75 | 200 |

Tensile Testing on Films Produced by Blown Film Extrusion

Preparation of Test Specimens

The tensile test specimens were obtained by cutting rectangles (150 mm×15 mm) out of the films. Cutting was performed using a press surmounted by a cutting blade. Cutting was made in longitudinal direction and transverse direction.

Tensile Test

Young's modulus (MPa), stress at failure (MPa) and elongation at break (%) were measured by tensile tests on a Lloyd LR10k machine. All measurements were taken under normal conditions of temperature (23±2° C.) and hygrometry (50±5% relative humidity). The distance between jaws was set at 80 mm. Measurements were taken at a rate of 100 mm/min. Strain was measured by following movement of the crosshead. Young's modulus was measured considering the slope of the initial section of the curve.

Results:

SEM of Compounds

The SEM images obtained show PLA regions dispersed in the PBAT matrix. The size of the PLA regions is smaller in compound C compared with compound C ref. This better dispersion and homogeneity is an indication that PPGDGE plays a compatibilizing role in compound C.

DSC of the Films

DSC results show two Tg for the films produced (Table 4): one at low temperature, close to −30° C. and equivalent to that of pure PBAT; one at a higher temperature close to 60° C. and equivalent to that of pure PLA. Observation of these 2 Tg indicates the immiscibility of PLA and PBAT and confirms the result of SEM observations namely the presence of a dispersed phase of PLA in PBAT.

The DSC results show that the materials derived from the invention have properties differing from those of patent EP 2 844 685 B1. In this patent, the materials are amorphous and monophase (only one Tg observed).

Film Tearing

The results of film tearing are given in Table 3.

TABLE 3

| | Tested | Tear strength | |
|---|---|---|---|
| | direction | (N/mm) | |
| F ref | MD | 42.6 | (−16.2; +12.4) |
| | TD | 32.8 | (−12.3 +18.7) |
| F | MD | 56.4 | (−28.6; +13.0) |
| | TD | 62.7 | (−4.8; +6.6) |

The results of film tearing show greater tear strength for the film containing PPGDGE. They again evidence the compatibilizing effect of PPGDGE.

The discriminating property of film to meet bag industry specifications is tear strength. Specifications of this industry require that films reach the following value: tear strength of 30 N/mm in transverse direction under the conditions of standard DIN EN ISO 6383-1 at 200 mm/min. Consequently, the values obtained show that the targeted specifications are reached by the film derived from the invention.

Film Tensile Strength

The results of tensile testing on the films are given in Table 4.

TABLE 4

| | | Young’s | | Stress at | | Elongation | |
|---|---|---|---|---|---|---|---|
| | Tested | modulus | | failure | | at break | |
| | direction | (MPa) | | (MPa) | | (%) | |
| F ref | MD | 283 | (69) | 12.1 | (3.5) | 29 | (25.0) |
| | TD | 287 | (111) | 10.6 | (5.6) | 69 | (48) |
| F | MD | 233 | (21) | 13.3 | (0.8) | 33 | (5) |
| | TD | 213 | (27) | 9.3 | (1.5) | 60 | (32) |

The values of tensile results for film F are less dispersed than those of film F ref. The presence of PPGDGE therefore improves the homogeneity of the material.

The improvement in PLA dispersion in PBAT, in tear strength and homogeneity of tensile test results in the film containing PPGDGE, could be the consequence of chain coupling reactions between PLA and PBAT, initiated by PPGDGE.

### Example 2

Production of the Compounds

The granules were produced on a co-rotating twin-screw Clextral Evolum 25 HT extruder. For dispensing of the polymers (PLA Ingeo 4043D from Natureworks and PBAT A400 from Kingfa) a gravimetric feeder was used and the liquid PPGDGE of reference DER™ 732 P EPDXY RESIN, marketed by Olin, was metered using a PCM pump.

The mixture of PLA and PBAT was fed into the initial portion of the screw. The mixture was melted and conveyed into the PPGDGE feed zone.

The granules were prepared under the same conditions with a screw speed of 650 rpm and flow rate of 40 kg/h.

The parameters applied to extrude the granules are given in Table 5.

TABLE 5

| Zone | Z1 | Z2 | Z3 | Z4 | Z5 | Z6 | Z7 | Z8 | Z9 | Z10 | Z11 |
|---|---|---|---|---|---|---|---|---|---|---|---|
| Temperature | 50 | 195 | 195 | 195 | 195 | 195 | 195 | 195 | 195 | 195 | 195 |

The mixture of components arrives in the molten state in the last zone of the twin-screw (Z11) and is immediately granulated with an underwater cutting system to obtain half-moon shaped granules having a diameter of less than 3 mm.

Four compositions were prepared: composition 1 corresponding to the state of the art comprising 30% PLA and 70% de PBAT; composition 2 of the invention comprising 30% PLA, 69.5% PBAT and 0.5% PPGDGE; composition 3 of the invention comprising 30% PLA, 69% PBAT and 1% PPGDGE; and composition 4 of the invention comprising 30% PLA, 68.5% PBAT and 1.5% PPGDGE (weight % relative to the total weight of the composition).

Production of the Film with the Compositions Described Under A)

Compositions 1 to 4 prepared under A) were used for preparation of the films. For blown film extrusion, a Labtech LF-250 laboratory line was used, lay-flat width 20 mm, L/D 30 screw of LBE20-30/C type. Screw speed was 60 rpm. The blow-up ratio was about 5.

Settings of blown film extrusion temperatures are given in Table 6.

TABLE 6

| Zone | Z1 | Z2 | Z3 | Z4 | Die #1 | Die #2 |
|---|---|---|---|---|---|---|
| Temperature (° C.) | 160 | 160 | 160 | 160 | 155 | 160 |

Films 1, 2, 3 and 4 of compositions 1, 2, 3 and 4 have a mean thickness of 15 μm. Thicknesses were measured with a micrometer.

These films are transparent without roughness and no through defect was identified. For each air expansion, the bubble remained stable.

Characterization of Mechanical Tear and Uniaxial Tensile Properties

The films were mechanically characterized for tear and uniaxial tensile properties on a Lloyd LS5 testing machine equipped with a 20 N load cell and following standards EN ISO 527-3 and EN ISO 6383-1 respectively. The experimental conditions per type of test are summarized in Table 7.

TABLE 7

| | | Distance | Crosshead |
|---|---|---|---|
| | Sample | between jaws | speed |
| Test | size | (mm) | (mm/min) |
| Uniaxial tension | 15*150 | 80 | 100 |
| Tear | 50*150 | 75 | 200 |

The discriminating properties of the film to meet bag industry specifications are elongation at break and tear strength.

The characteristics of elongation at break and tear strength of the composition are given in Table 8 (MD=Longitudinal Direction, TD=Transverse Direction).

TABLE 8

| | Test | Elongation at | Tear strength |
|---|---|---|---|
| Film | direction | break (%) | (N/mm) |
| Film 1 | MD | 180 | 18.2 |
| | TD | 167 | 20.2 |
| Film 2 | MD | 148 | 19.8 |
| | TD | 141 | 18.5 |
| Film 3 | MD | 215 | 23 |
| | TD | 183 | 21.3 |
| Film 4 | MD | 221 | 20.7 |
| | TD | 210 | 19 |

It is recalled that bag industry specifications require that films reach the following values:

Elongation at break which measures the capacity of a material to elongate under a load before breaking:

120% in Longitudinal Direction

180% in Transverse Direction

Tear Strength:

Equivalent to or higher than the values obtained for the reference film (film 1) i.e. 18 N/mm in longitudinal direction and 20 N/mm in transverse direction under the conditions of standard DIN EN ISO 6383-1 at 200 mm/min

Films 3 and 4 comprising the compositions described in the invention, with 1% PPGDGE in the composition of film 3 and 1.5% PPGDGE in the composition of film 4, allow the elongation at break targeted in bag industry specifications to be reached in both directions of measurement. Tear strength is improved compared with film 1 corresponding to the state of the art. In general, the properties of elongation at break and tear strength are greater than those of film 1 corresponding to the state of the art.

The addition of 0.5% PPGDGE to the formulation is not sufficient to achieve the sought-after properties. The values of elongation at break and tear strength are lower than those of the prior art film.

The characteristics of elastic modulus and maximum stress of the films are given in Table 9.

TABLE 9

| | | Elastic | Maximum |
|---|---|---|---|
| | Test | modulus | stress |
| Film | direction | (MPa) | (MPa) |
| Film 1 | MD | 1040 | 21.7 |
| | TD | 267 | 16.4 |
| Film 2 | MD | 1202 | 27.9 |
| | TD | 336 | 15.6 |
| Film 3 | MD | 1086 | 32 |
| | TD | 261 | 14.8 |
| Film 4 | MD | 1226 | 35.33 |
| | TD | 284 | 19.4 |

It is recalled that bag industry specifications require that films reach the following values:

Elastic modulus: 700 MPa in Longitudinal Direction

210 MPa in Transverse Direction

Maximum stress: 20 MPa in Longitudinal Direction

13 MPa in Transverse Direction

All the films derived from the invention exhibit the properties of elastic modulus and maximum stress required by specifications.

The elastic modulus of film 1 having a composition which is not covered by the invention is lower than that of films 2, 3 and 4 derived from the invention.

Film 1 having a composition not covered by the invention shows maximum stress in longitudinal direction that is lower than that of the films having the compositions described in the invention.

### Example 3

Production of the Compounds

The granules were produced on a co-rotating twin-screw Clextral Evolum 25 HT extruder. For dispensing of the polymers (PLA Ingeo 4043D from Natureworks and PBAT A400 from Kingfa) a gravimetric feeder was used and the liquid PPGDGE of reference DER™ 732P EPDXY RESIN, marketed by Olin, was metered using a PCM pump.

The mixture of PLA and PBAT was fed into the initial portion of the screw in the presence of PPGDGE and mineral filler, if any, in the formulation. The mixture was melted and conveyed into the granulating zone.

The granules were prepared under the same conditions with a screw speed of 650 rpm and flow rate of 40 kg/h.

The parameters applied for extrusion of the granules are given in Table 10.

TABLE 10

| Zone | Z1 | Z2 | Z3 | Z4 | Z5 | Z6 | Z7 | Z8 | Z9 | Z10 | Z11 |
|---|---|---|---|---|---|---|---|---|---|---|---|
| Temperature | 50 | 195 | 195 | 195 | 195 | 195 | 200 | 200 | 200 | 200 | 200 |

The mixture of components arrives in the last zone of the twin-screw (Z11) and is immediately granulated with an underwater cutting system to obtain half-moon shaped granules having a diameter of less than 3 mm.

Three compositions were prepared: composition 5 of the invention comprising 30% PLA, 69% PBAT and 1% PPGDGE; composition 6 of the invention comprising 35% PLA, 64% PBAT and 1% PPGDGE; and composition 7 of the invention comprising 35% PLA, 62% PBAT, 2% CaCO3 and 1.5% PPGDGE (weight % relative to the total weight of the composition).

Production of the Film with the Compositions Described Under A)

Compositions 1 to 4 prepared under A) were used to prepare films. For blown film extrusion, a Labtech LF-250 laboratory line was used, lay-flat width 20 mm, L/D 30 screw of LBE20-30/C type. The screw speed was 60 rpm. The blow-up ratio was about 5.

The temperature settings for blown film extrusion are given in Table 11.

TABLE 11

| Zone | Z1 | Z2 | Z3 | Z4 | Die #1 | Die #2 |
|---|---|---|---|---|---|---|
| Temperature (° C.) | 160 | 160 | 160 | 160 | 155 | 160 |

Film 5 of composition 5 has a mean thickness of 15 μm. Film 6 of composition 6 has a mean thickness of 15.5 μm. Film 7 of composition 7 has a mean thickness of 14.8 μm Thicknesses were measured with a micrometer.

These films are transparent, without roughness and no through defect was observed. For each air expansion the bubble was stable.

Characterization of Mechanical Tear and Uniaxial Tensile Properties

The films were mechanically characterized with tear and uniaxial tensile tests on a Lloyd LS5 testing machine equipped with a 20 N load cell following standards EN ISO 527-3 and EN ISO 6383-1 respectively. The experimental conditions per type of test are summarized in Table 12.

TABLE 12

| | | Distance | Crosshead |
|---|---|---|---|
| | Sample | between jaws | speed |
| Test | size | (mm) | (mm/min) |
| Uniaxial tension | 15*150 | 80 | 100 |
| Tear | 50*150 | 75 | 200 |

The discriminating properties of the film to meet bag industry specifications are elongation at break and tear strength.

The characteristics of elongation at break and tear strength of the composition are given in Table 13.

TABLE 13

| | Test | Elongation at | Tear strength |
|---|---|---|---|
| Film | direction | break (%) | (N/mm) |
| Film 5 | MD | 215 | 23 |
| | TD | 183 | 21.3 |
| Film 6 | MD | 147 | 13.6 |
| | TD | 272 | 15.7 |
| Film 7 | MD | 130 | 15.1 |
| | TD | 333 | 15.7 |

It is recalled that bag industry specifications require that films reach the following values:

Elongation at break, which measures the capacity of a material to elongate under load before breaking:

120% in Longitudinal Direction

180% in Transverse Direction

Tear Strength:

Equivalent to or higher than the values obtained for the reference film (film 1) i.e. 18 N/mm in longitudinal direction and 20 N/mm in transverse direction under the conditions of standard DIN EN ISO 6383-1 at 200 mm/min

Films 5 and 6 comprising the compositions described in the invention, with 30% PLA and 1% PPGDGE in the composition of film 5 and 35% PLA and 1% PPGDGE in the composition of film 6, allow bag industry specifications to be met for elongation at break. An increase in PLA content allows better elongation at break to be obtained in transverse direction.

Films 6 and 7 comprising the compositions described in the invention, with 35% PLA and 1% PPGDGE in the composition of film 6 and 35% PLA, 2% CaCO3 and 1% PPGDGE in the composition of film 7, allow bag industry specifications to be met for elongation at break. The addition of CaCO3 to the formulation allows better elongation at break to be obtained in the transverse direction and improved tear strength in longitudinal direction.

The characteristics of elastic modulus and maximum stress of the films are given in Table 14.

TABLE 14

| | | Elastic | Maximum |
|---|---|---|---|
| | Test | modulus | stress |
| Film | direction | (MPa) | (MPa) |
| Film 5 | MD | 1086 | 32 |
| | TD | 261 | 14.8 |
| Film 6 | MD | 1361 | 29 |
| | TD | 442 | 22 |
| Film 7 | MD | 1324 | 27 |
| | TD | 377 | 26 |

It is recalled that bag industry specifications require that films reach the following values:

Elastic modulus: 700 MPa in Longitudinal Direction

210 MPa in Transverse Direction

Maximum stress: 20 MPa in Longitudinal Direction

13 MPa in Transverse Direction

All the films derived from the invention have properties of elastic modulus and maximum stress as required by specifications.

Films 5 and 6 comprising the compositions described in the invention, with 30% PLA and 1% PPGDGE in the composition of film 5 and 35% PLA and 1% PPGDGE in the composition of film 6 allow bag industry specifications to be met. The increase in PLA content improves elastic modulus as well as maximum stress.

Films 6 and 7 comprising the compositions described in the invention, with 35% PLA and 1% PPGDGE in the composition of film 6 and 35% PLA, 2% CaCO3 and 1% PPGDGE in the composition of film 7, allow bag industry specifications to be met. The addition of CaCO3 to the formulation allows improved properties to be obtained in transverse direction.

### Example 4

Production of the Compounds

The granules were produced on a co-rotating twin-screw Clextral Evolum 25 HT extruder. For dispensing of the polymers (PLA Ingeo 4043D from Natureworks and PBAT A400 from Kingfa) a gravimetric feeder was used and the liquid PPGDGE of reference DER™ 732 P EPDXY RESIN, marketed by Olin, was metered using a PCM pump.

The mixture of PLA and PBAT was fed into the initial portion of the screw in the presence of PPGDGE and plasticizer TBAC. The mixture was melted and conveyed into the granulating zone.

The granules were prepared under the same conditions with a screw speed of 650 rpm and flow rate of 40 kg/h.

The parameters applied for extrusion of the granules are given in Table 15.

TABLE 15

| Zone | Z1 | Z2 | Z3 | Z4 | Z5 | Z6 | Z7 | Z8 | Z9 | Z10 | Z11 |
|---|---|---|---|---|---|---|---|---|---|---|---|
| Temperature | 50 | 195 | 195 | 195 | 195 | 195 | 200 | 200 | 200 | 200 | 200 |

Two compositions were prepared: composition 8 of the invention comprising 35% PLA, 64% PBAT and 1% PPGDGE, and composition 9 of the invention comprising 35% PLA, 61.35% PBAT, 2.5% TBAC and 1.15% PPGDGE (weight % relative to the total weight of the composition).

Production of the Film with the Compositions Described Under A)

Compositions 1 to 4 prepared under A) were used to prepare films. For blown film extrusion, a Labtech LF-250 laboratory line was used, lay-flat width 20 mm, 30 L/D screw of LBE20-30/C type. The screw speed was 60 rpm. The blow-up ratio was about 5.

The temperature settings for blown film extrusion are given in Table 16.

TABLE 16

| Zone | Z1 | Z2 | Z3 | Z4 | Die #1 | Die #2 |
|---|---|---|---|---|---|---|
| Temperature (° C.) | 160 | 160 | 160 | 160 | 155 | 160 |

Films 8 and 9 of composition 8 and 9 have a mean thickness of 15.5 μm. Thicknesses were measured with a micrometer.

These films are transparent, without roughness and no through defect was observed. For each air expansion the bubble was stable.

Characterization of Mechanical Tear and Uniaxial Tensile Properties

The films were mechanically characterized with tear and uniaxial tensile tests on a Lloyd LS5 testing machine equipped with a 20 N loadcell following standards EN ISO 527-3 and EN ISO 6383-1 respectively. The experimental conditions per type of test are summarized in Table 17.

TABLE 17

| | | Distance | Crosshead |
|---|---|---|---|
| | Sample | between jaws | speed |
| Test | size | (mm) | (mm/min) |
| Uniaxial tension | 15*150 | 80 | 100 |
| Tear | 50*150 | 75 | 200 |

The discriminating properties of the film to meet bag industry specifications are elongation at break and tear strength.

The characteristics of elongation at break and tear strength of the composition are given in Table 18.

TABLE 18

| | Test | Elongation at | Tear strength |
|---|---|---|---|
| Film | direction | break (%) | (N/mm) |
| Film 8 | MD | 147 | 13.6 |
| | TD | 272 | 15.7 |
| Film 9 | MD | 198 | 15.4 |
| | TD | 191 | 18.2 |

It is recalled that bag industry specifications require that films reach the following values:

Elongation at break which measures the capacity of a material to elongate under a load before breaking:

120% in Longitudinal Direction

180% in Transverse Direction

Tear Strength:

Equivalent to or higher than the values for the reference film (film 1) i.e. 18 N/mm in longitudinal direction and 20 N/mm in transverse direction under the conditions of standard DIN EN ISO 6383-1 at 200 mm/min.

Films 8 and 9 comprising the compositions described in the invention, with 1% PPGDGE in the composition of film 8 and 1.15% PPGDGE+2.5% TBAC in the composition of film 9, allow bag industry specifications to be met for elongation at break. The addition of plasticizer allows an improvement in the properties of elongation at break and also the tear strength of the films.

The characteristics of elastic modulus and maximum stress of the films are given in Table 19.

TABLE 19

| | | Elastic | Maximum |
|---|---|---|---|
| | Test | modulus | stress |
| Film | direction | (MPa) | (MPa) |
| Film 5 | MD | 1361 | 29 |
| | TD | 442 | 22 |
| Film 6 | MD | 1330 | 29.4 |
| | TD | 314 | 14.2 |

It is recalled that bag industry specifications require that films reach the following values:

Elastic modulus: 700 MPa in Longitudinal Direction; 210 MPa in Transverse Direction.

Maximum stress: 20 MPa in Longitudinal Direction; 13 MPa in Transverse Direction.

All the films derived from the invention exhibit properties of elastic modulus and maximum stress as required by specifications.

1. A plastic material composition comprising:
a. at least 20% by weight of polylactic acid (PLA),
b. at least 45% by weight of a polyester selected from polybutylene adipate terephthalate (PBAT), polyhydroxyalkanoates (PHAs), polybutylene succinate (PBS), polybutylene succinate adipate (PBSA), and mixtures thereof,
c. Poly (Propylene Glycol) DiGlycidyl Ether (PPGDGE), as PLA/Polyester compatibilizer, and optionally
d. a plasticizer.

2. The composition according to claim 1, wherein the polyester b) is PBAT.

3. The composition according to claim 1, wherein the composition comprises at least 25% by weight of PLA.

4. The composition according to claim 1, wherein the content of polyester b) is at least 50% of the total weight of the composition.

5. The composition according to claim 1, wherein the content of compatibilizer c) is from 0.5 to 2% by weight relative to the total weight of the composition.

6. The composition according to claim 1, wherein the composition further comprises polyester-degrading enzymes.

7. (canceled)

8. A method for preparing the composition according to claim 1, wherein the method comprises the steps of:
1) mixing the PLA a) and compatibilizer c) selected from polyacrylates at a temperature at which the PLA is partially of fully molten,
2) adding polyester b) selected from PBAT, PHAs, PBS, and mixtures thereof at a temperature at which the previously obtained mixture is molten.

9. A plastic film having the composition according to claim 1.

10. The composition according to claim 1, wherein the composition further comprises PLA/polyester compatibilizers associated with PPGDGE, the PLA/polyester compatibilizers being selected from polyacrylates, terpolymers of ethylene, acrylic ester and glycidyl methacrylate, PLA-PBAT-PLA triblock copolymers, maleic anhydride-grafted PLAs and maleic anhydride-grafted PBATs.

11. The composition according to claim 10, wherein the content of additional PLA/polyester compatibilizers associated with PPGDGE is from 0.2 to 2%.

12. The composition according to claim 1, wherein the plasticizer is selected from lactic acid oligomers (LAOS) and citrate esters.

13. The composition according to claim 12, wherein the content of plasticizer is of at least 0.5% by weight.

14. The composition according to claim 12, wherein the content of plasticizer is from 1 to 5% by weight.

15. The composition according to claim 3, wherein the composition comprises at least 30% by weight of PLA.

16. The composition according to claim 4, wherein the content of polyester b) is comprised between 60 and 70% of the total weight of the composition.

17. The composition according to claim 5, wherein the content of compatibilizer c) is from 0.5 to 1.5% by weight relative to the total weight of the composition.

18. The composition according to claim 6, wherein the polyester-degrading enzymes are PLA-degrading enzymes.

19. A plastic material composition comprising:
a. at least 25% by weight of polylactic acid (PLA),
b. at least 60% by weight of a polyester selected from polybutylene adipate terephthalate (PBAT), polyhydroxyalkanoates (PHAs), polybutylene succinate (PBS), polybutylene succinate adipate (PBSA), and mixtures thereof,
c. 0.5 to 1.5% by weight of poly (Propylene Glycol) diGlycidyl ether (PPGDGE), as PLA/Polyester compatibilizer,
d. 0 to 2% by weight of another compatibilizer, and
e. 0 to 4% by weight of a plasticizer.

20. The method according to claim 8, wherein the method further comprises the addition of a plasticizer selected from lactic acid oligomers (LAOS) and citrate esters.

21. The method according to claim 20, wherein the addition of the plasticizer is made at any instant of the method.

22. The plastic film according to claim 9, wherein the composition further comprises polyester-degrading enzymes

23. The plastic film according to claim 9, wherein the plastic film has an elongation at break greater than 120% in longitudinal direction and an elongation break greater than 180% in transverse directions measured to standard ISO EN 527-3, a tear strength greater than 20 N/mm in transverse direction of the film, measured according to standard EN ISO 6383-1, and a high PLA content.
